(19) United States
(12) Patent Application Publication
(10) Pub. No.: US 2003/0112978 A1
(43) Pub. Date: Jun. 19, 2003

(54) System and method for secured data transmission within a wireless communication system

(76) Inventors: Jeffrey Rodman, San Francisco, CA (US); Gil Pearson, Notodden (NO)

Correspondence Address: CARR & FERRELL LLP, 2225 EAST BAYSHORE ROAD, SUITE 200, PALO ALTO, CA, 94303, US

(21) Appl. No.: 10/072,797

(22) Filed: Feb. 7, 2002

Related U.S. Application Data
(63) Continuation-in-part of application No. 10/023,572, filed on Dec. 17, 2001.

(51) Int. Cl. H04L 9/00

(52) U.S. Cl. 380/277; 380/270

(57) ABSTRACT

A system and method are provided for securing data transmission during operation of a wireless networked communication system comprising a base station and one or more remote devices. The base station generates an encryption key, encodes the key as an acoustic signal, and transmits the signal. The acoustic signal is received by all co-located remote devices of the communication system, and decoded to extract the encryption key. Subsequent communication transmissions between and among the base station and the remote device are encrypted using the encryption key to prevent electronic eavesdropping.

### CROSS-REFERENCE TO RELATED APPLICATION

This application claims the benefit and is a continuation-in-part of U.S. patent application Ser. No. 10/023,572 entitled “System and Method for Device Co-Location Discrimination,” which is incorporated herein by reference.

### BACKGROUND OF THE INVENTION

1. Field of the Invention

The invention relates generally to communication systems, and more particularly to a system and method for the transmission of secured data within a communication system having wireless networked components.

2. Description of the Background Art

Business communication systems, such as audio conferencing or video conferencing systems, are making increasing use of wireless networks to link system components, such as microphones, speakers, and the like. Use of wireless networks avoids the need to cable the system components together, thereby simplifying system setup and allowing the system components to be easily rearranged to suit the needs of the user(s). The use of wireless networks to link system components also offers significant aesthetic benefits by eliminating or reducing unsightly wiring.

A disadvantage associated with wireless networked communication systems is the potential for unintended dissemination of confidential or sensitive information. In a business conference setting, it is frequently desirable to limit access to information being discussed or viewed to conference participants only. To this end, the conference systems are typically located in a fully enclosed space, i.e., a conference room. However, most commercially available wireless networked communication systems employ radio-frequency (RF) signals to convey information between and among the various system components. Such RF signals may easily penetrate the walls, ceiling, etc. of the conference room and may thus be inadvertently transmitted to other devices capable of receiving the signals, e.g., a component of another wireless networked system located in a second conference room. Transmission of the RF signals outside of the conference room may also allow interception by eavesdroppers or industrial spies, thereby compromising confidentiality.

One method of preventing the inadvertent dissemination of confidential information is to encode the transmitted RF signals using an encryption key, essentially scrambling the underlying information. The signals are subsequently decoded at the receiving component using the same or a complementary encryption key. However, this method requires all components within the communication system to possess the same encryption key in order to properly encode and/or decode the RF signals. One technique for assigning a common encryption key for all wireless networked components within a communication system involves manually entering the encryption key (by setting switches or through a keypad) at each component. However, this technique is time-consuming and subject to user error. Another technique for assigning the encryption key is to initially (i.e., at the start of system operation) distribute the key using unencrypted RF signals. Unfortunately, an eavesdropper monitoring the RF transmissions can intercept the transmitted encryption key and use the encryption key to decode subsequent transmissions.

Accordingly, there is a need for an improved system and method for securely transmitting information between components of a wireless communication system. There is more specific need for a system and method for distributing an encryption key among the system components which does not require substantial operator intervention, and which is not susceptible to eavesdroppers monitoring the transmission frequencies.

### SUMMARY OF THE INVENTION

The present invention provides a system and method for securely transmitting information between and among components of a wireless networked communication system. In a preferred embodiment, the components of the communication system include a base station containing the primary system circuitry, and a set of physically co-located remote devices (microphones, speakers, personal computers, LCD projectors, video monitors, and the like) which normally communicate with the base station and with each other by transmission and reception of RF signals.

However, an encryption key is distributed using an acoustic signal. To implement the distribution of the encryption key by an acoustic signal, the base station is provided with an acoustic transmitter (i.e., a speaker), and each remote device is provided with an acoustic sensor (i.e., a microphone). At the commencement of system operation, the base station generates an encryption key, converts the encryption key into an acoustic signal, and transmits the signal. For example, the encryption key may comprise a randomly generated n-digit sequence of numbers which is converted to a corresponding sequence of DTMF tones.

Each of the remote devices is provided with an acoustic sensor for detecting the acoustic signal transmitted by the base station. The acoustic sensor responsively generates an electrical signal, which is passed to an acoustic codec. The acoustic codec is operative to extract a digital representation of the encryption key for storage in a memory. The encryption key is subsequently utilized by the base station and remote devices to encrypt and decrypt conference data passed between and among the devices and the base station through RF signals. Use of the acoustic signal to distribute the encryption key effectively prevents non-co-located devices (i.e., those located outside of a conference room) from detecting the encryption key.

### BRIEF DESCRIPTION OF THE DRAWINGS

FIG. 1 is a block diagram showing components of a wireless networked communication system located within a conference room;

FIG. 2 is a block diagram of a base station and an exemplary remote device of the present invention; and

FIG. 3 is a flowchart showing the steps of a method for distributing an encryption key by transmission and reception of an acoustic signal, in accordance with the present invention.

### DETAILED DESCRIPTION OF THE PREFERRED EMBODIMENT

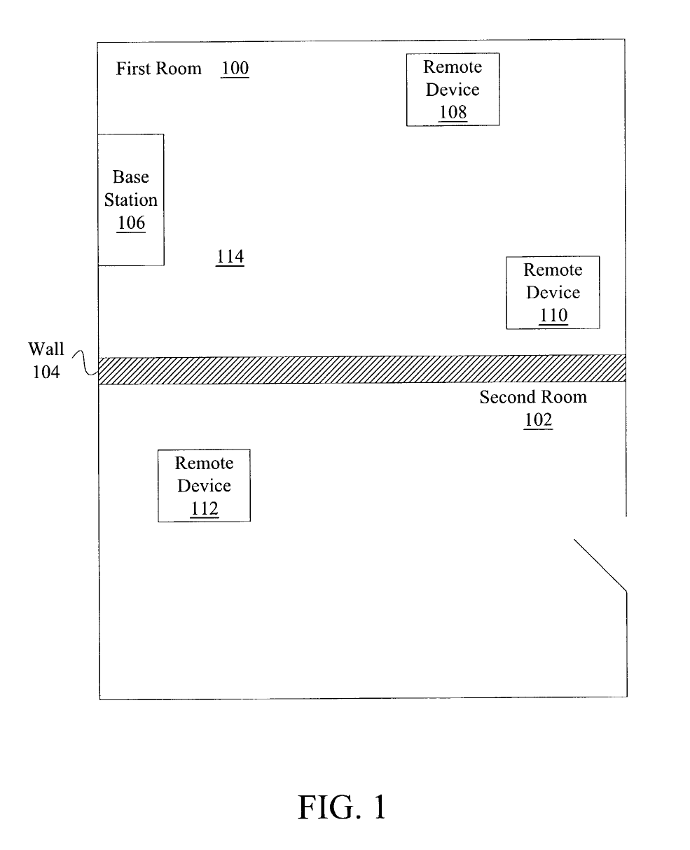

FIG. 1 depicts components of an exemplary wireless networked communication system 114 located within an enclosed first conference room 100. Communication system 114 may comprise, but is not limited to, a video conferencing or audio conferencing system of the type sold by Polycom, Inc. of San Jose, Calif. Communication system 114 includes a base station 106 which contains the primary system circuitry, and a plurality of remote devices, such as remote devices 108 and 110, which communicate with base station 106 and with each other by the transmission and reception of electromagnetic signals, typically radio frequency (RF) signals. Some examples of remote devices are microphones, speakers, personal computers, LCD projectors, and video monitors. Base station 106 may be additionally configured to manage communications with other communication systems (e.g., video conferencing systems located at other sites) over conventional circuit or packet switched networks, such as the public switched telephone network or the Internet. It is noted that while two remote devices 108 and 110 are depicted in the figure, a lesser or greater number of remote devices may be utilized.

FIG. 1 also depicts a second conference room 102 adjacent to first conference room 100 and separated therefrom by a wall 104. Remote device 112, which is not part of communication system 114, is located within second conference room 102. Because RF signals transmitted by base station 106 and remote devices 108 and 110 may easily penetrate wall 104 and reach remote device 112, the information underlying the transmitted RF signals may be inadvertently disseminated to persons having access to remote device 112. If such information is sensitive or proprietary, the confidentiality of the information may thus be compromised.

An object of the present system and method is to secure against inadvertent disclosure of confidential information by encrypting the conference data transmitted between and among base station 106 and remote devices 108 and 110. The term “conference data”, as used herein, denotes data representative of any information which may be presented to users of communication system 114 during operation thereof, including speech, images, and the like. To successfully encrypt and decrypt the conference data, base station 106 and remote devices 108 and 110 must possess a common encryption key. In accordance with the present system and method, the encryption key is distributed by the transmission and reception of an acoustic signal. Because acoustic signals are attenuated relatively rapidly and do not readily penetrate walls such as wall 104, devices located outside of first conference room 100 are unable to detect the transmission of the acoustically-encoded encryption key, and hence cannot decrypt subsequently received RF signals (including those representative of confidential information) emanating from communication system 114.

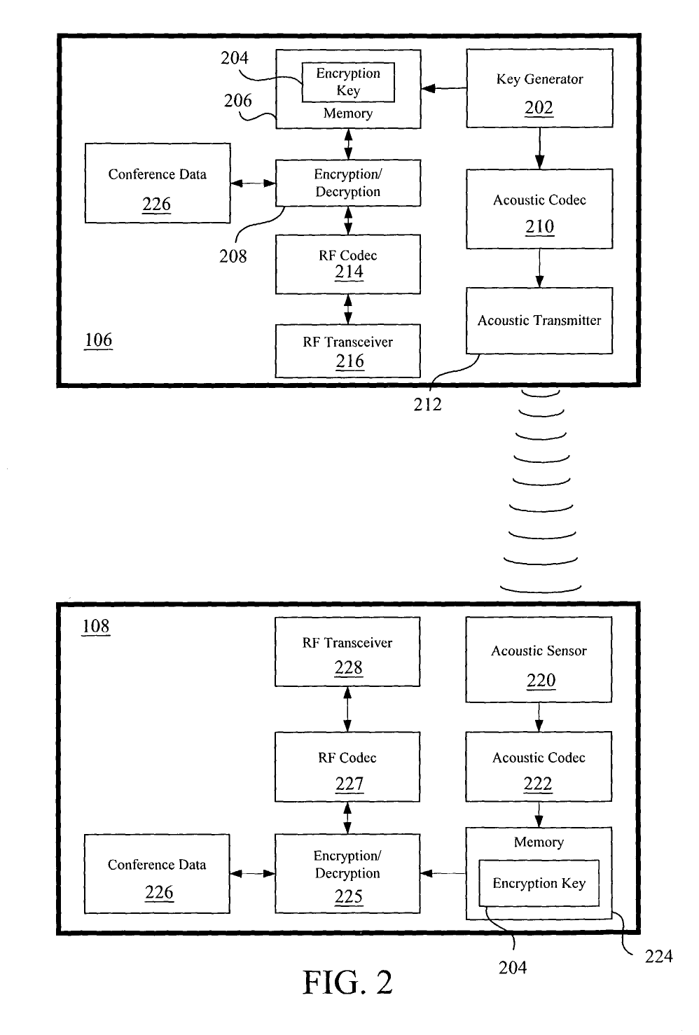

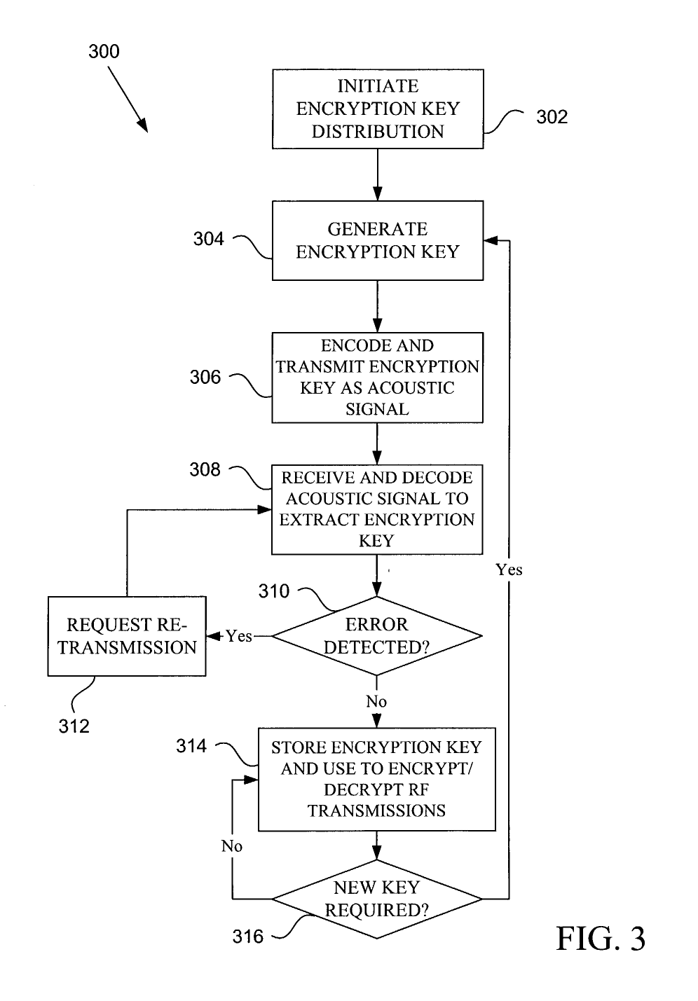

The distribution of an encryption key via an acoustic-based expedient is best understood with reference to the block diagram of FIG. 2 and the flowchart of FIG. 3. Referring initially to FIG. 2, components of base station 106 and an exemplary one of the remote devices 108 are depicted in schematic form. Base station 106 is provided with an encryption key generator 202 configured to randomly generate an encryption key 204 in accordance with well-known random key generation algorithms. Encryption key 204 may comprise, for example, a randomly generated n-digit string. Encryption key 204 is stored in memory 206 for subsequent use by encryption/decryption module 208.

Encryption key 204 is additionally conveyed to an acoustic codec 210, which is electrically coupled to an acoustic transmitter 212. Acoustic codec 210 is configured to apply an electrical signal to acoustic transmitter 212 which causes acoustic transmitter 212 to emit an acoustic signal (i.e., sounds) which encodes the encryption key. In one example, the n-digit encryption key is encoded as a string of dual-tone multi-frequency (DTMF) tones. Those skilled in the art will recognize that acoustic codec 210 may utilize a variety of alternative methods for encoding encryption key 204 as an acoustic signal, including without limitation modem tones, musical chords, and spread-spectrum modulation.

In any case, acoustic transmitter 212, which may comprise a conventional loudspeaker, emits the acoustic signal encoded encryption key 204. It is appreciated that the acoustic signal power should be sufficient to enable co-located remote devices to detect the signal, but the power should be minimized to prevent detection of the signal outside of conference room 100 (FIG. 1) as well as to avoid subjecting persons present within conference room 100 to an unpleasantly harsh sound.

The acoustic signal propagates through conference room 100 (FIG. 1) and is received at remote device 108. As depicted in FIG. 2, remote device 108 is provided with an acoustic sensor 220, which may comprise a conventional microphone. Acoustic sensor 220 is operative to detect the acoustic signal encoded encryption key 204 (for example, a string of DTMF tones) and to responsively generate a corresponding electrical signal. The electrical signal is passed to an acoustic codec 222, which is configured to extract a digital representation of encryption key 204 for storage in a memory 224. Encryption key 204 may subsequently be accessed by encryption/decryption module 225 to encrypt conference data 226 transmitted to base station 106 or other co-located devices and to decrypt conference data 226 received from base station 106 or other co-located devices of the communication system 114 (FIG. 1).

Once encryption key 204 has been distributed to remote device 108 (as well as to the other remote devices of communication system 114 of FIG. 1), encryption key 204 is utilized to encrypt and decrypt conference data 226 transmitted by RF signals between and among the various components of communication system 114. Base station 106 is provided with an encryption/decryption module 208, RF codec 214, and RF transceiver 216. Similarly, remote device 108 is provided with encryption/decryption module 225, RF codec 227, and RF transceiver 228. Those skilled in the art will recognize that the encryption/decryption modules 208 and 225 and the RF codecs 214 and 227 may be configured as hardware, software, or a combination thereof.

In a transmit mode, conference data 226 (which may comprise speech, images, and the like, as discussed above), is encrypted by encryption/decryption module 208 or 225 using encryption key 204. Encryption/decryption module 208 or 225 may employ any one of a large number of encryption techniques well known in the art. The encrypted conference data is then encoded by codec 214 or 227 for transmission as RF signals by RF transceiver 216 or 228. Because the RF signals contain encrypted (i.e., unintelligible) information, eavesdroppers and others who intercept the RF signals will not have access to underlying conference data 226.

In the receive mode, RF signals transmitted by another component of communication system 114 (FIG. 1) are received by RF transceiver 216 or 228, and converted to a digital representation of the encrypted conference data by RF codec 214 or 227. The encryption/decryption module 208 or 225 is then operative to decrypt conference data 226, which may be subsequently used for a variety of purposes. In one example, remote device 108 may comprise a microphone which generates conference data representative of the speech of conference participants. The conference data representative of the speech is encrypted and transmitted to base station 106 by RF signals. Base station 106 receives the RF signals, decrypts the underlying conference data, and conveys this data to another communication system over a telephone network.

It is noted that while remote device 108 is depicted as having an RF transceiver 228, other remote devices may be adapted for unidirectional RF communications with base station 106 (i.e., either from base station 106 to the remote device, or from the remote device to base station 106). In such cases, an RF transmitter or receiver will be substituted for RF transceiver 228.

FIG. 3 is a flowchart 300 showing steps of an exemplary method for distributing encryption key 204 (FIG. 2) using an acoustic signal in accordance with the present system and method. In step 302, the key distribution sequence is initiated. Step 302 may be triggered automatically, as by turning on communication system 114 (FIG. 1), or may be triggered manually by a user engaging a “reset” control or the like. Next, encryption key generator 202 (FIG. 2) randomly generates encryption key 204 and stores encryption key 204 in memory 206 (FIG. 2) in step 304. Encryption key 204 is then encoded by codec 210 (FIG. 2) and transmitted as an acoustic signal by acoustic transmitter 212 (FIG. 2) in step 306.

Next, the acoustic signal representative of encryption key 204 (FIG. 2) is received by acoustic sensor 220 (FIG. 2) of remote device 108 (FIG. 2) and decoded by acoustic codec 222 (FIG. 2) in step 308, to extract a digital representation of encryption key 204.

It may be desirable (particularly in environments having high levels of ambient noise, which may interfere with transmission and reception of the acoustic signal) to provide an error detection scheme (using a transmitted checksum or similar method) within acoustic codec 222 (FIG. 2) to ensure that encryption key 204 (FIG. 2) is correctly transmitted and decoded. Therefore, in optional step 310, acoustic codec 222 performs an error detection step to determine if an error has occurred in connection with the reception/decoding of encryption key 204. If acoustic codec 222 detects an error condition, it sends a request to base station 106 (FIG. 2), via RF codec 227 (FIG. 2) and transceiver 228 (FIG. 2), to re-transmit the acoustic signal representative of encryption key 204 in step 312. If no error condition is detected, encryption key 204 is stored in memory 224 (FIG. 2) and used to encrypt and decrypt subsequent RF transmissions of conference data 226 (FIG. 2) in step 314.

The method may additionally include the step 316 of determining whether a new encryption key is required. Generation of a new encryption key may be triggered, for example, by expiration of a predetermined time period (security may be enhanced by periodically changing the encryption key) or by manual user request. If a new encryption key is required, the method returns to step 304; otherwise, the method returns to encrypting and decrypting conference data 226 (FIG. 2) using existing encryption key 206 (FIG. 2).

It is to be appreciated that although the embodiment depicted in FIG. 2 and described above locates encryption key generator 202 and acoustic transmitter 212 in base station 106, alternative embodiments which may locate these elements in one or more of the remote devices are within the scope of the invention.

It is further noted that the present invention is not intended to be limited in scope to acoustic transmission of the encryption key. Other types of signals, which do not easily penetrate conference room walls and hence are not detectable outside of the conference room, may be used to encode and distribute the encryption key. For example, the base station may be provided with an infrared (IR) transmitter for transmitting an IR signal encoding the encryption key. The associated remote devices are correspondingly provided with IR sensors for detecting the transmitted IR signal, and an IR codec for extracting the encryption key from the received signal. Distribution of the encryption key via an IR signal may be less attractive relative to use of an acoustic signal, since objects or persons located in the conference room may block the transmission path of IR signals, and thus prevent the reception of the IR signal by the remote devices.

The invention has been described above with reference to specific embodiments. It will be apparent to those skilled in the art that various modifications may be made and other embodiments can be used without departing from the broader scope of the invention. Therefore, these and other variations upon the specific embodiments are intended to be covered by the present invention, which is limited only by the appended claims.

What is claimed is:

1. A method for secure data transfer in a wireless networked communication system, comprising the steps of:
generating an encryption key within a first device of the communication system;
encoding the encryption key to form an encoded signal;
transmitting the encoded signal to a second device of the communication system remote from the first device;
decoding the encoded signal at the second device to extract the encryption key; and
using the encryption key to encrypt and decrypt data for subsequent wireless transmissions between the first and second devices.

2. The method of claim 1, wherein the encoded signal is an acoustic signal.

3. The method of claim 2, wherein the acoustic signal is DTMF tones.

4. The method of claim 1, wherein the encoded signal is an infrared signal.

5. The method of claim 1, wherein the step of decoding further comprises the step of storing the decoded encryption key in memory.

6. The method of claim 1, wherein the step of decoding further comprises the step of performing error detection to determine if an error has occurred in connection with the reception or decoding of the encryption key.

7. The method of claim 6, further comprising the step of sending a request for a retransmission of the encoded signal if an error is detected.

8. The method of claim 1, wherein the step of using the encryption key to encrypt and decrypt subsequent wireless transmissions further comprises the step of encoding the data into radio frequency signals.

9. The method of claim 1, further comprising the step of determining whether a new encryption key is required.

10. A system for secure data transmission within a wireless communication system, comprising:
a first device of the communication system, the first device having an encryption key generator for generating the encryption key and a signal transmitter for transmitting an encoded signal representative of the encryption key; and
a second device of the communication system, the second device having a signal sensor for receiving the encoded signal from the first device and a decoder device for extracting the encryption key from the encoded signal, the encryption key being used to encrypt data being transmitted between the first and second devices.

11. The system of claim 10 wherein the first device further comprises an encoder device for encoding the encryption key into an encoded signal for transmission.

12. The system of claim 11 wherein the encoder device is an acoustic codec.

13. The system of claim 10, wherein the encoded signal is an acoustic signal.

14. The system of claim 10, wherein the signal transmitter is an acoustic transmitter and the signal sensor is an acoustic sensor.

15. The system of claim 10, wherein the decoder device is an acoustic codec.

16. The system of claim 10 further comprising memory in the first and second devices for storage of the encryption key.

17. The system of claim 10 further comprising an encryption/decryption module in the first and second devices for encrypting data for transmission and decrypting data received from the other device.

18. The system of claim 10 further comprising a radio-frequency codec in the first and second devices for encoding the data into radio-frequency signals.

19. The system of claim 18 further comprising a radio-frequency transceiver in the first and second devices for transmission and reception of the radio-frequency signals within the communication system.

20. A system for secure data transmission within a wireless communication system, comprising:
means for generating an encryption key within a first device of the communication system;
means for encoding the encryption key to form an encoded signal;
means for transmitting the encoded signal to a second device of the communication system remote from the first device;
means for decoding the encoded signal at the second device to extract the encryption key; and
means for using the encryption key to encrypt and decrypt data for subsequent wireless transmissions between the first and second devices.
